(19) United States
(12) Patent Application Publication
(10) Pub. No.: US 2025/0122109 A1
(43) Pub. Date: Apr. 17, 2025

(54) Waste water treatment system

(71) Applicant: Wex Companies, Inc. dba Septic Check, Milaca, MN (US)

(72) Inventor: Brian Koski, Mora, MN (US)

(21) Appl. No.: 18/913,326

(22) Filed: Oct. 11, 2024

Related U.S. Application Data
(60) Provisional application No. 63/589,373, filed on Oct. 11, 2023.

(51) Int. Cl. C02F 3/20; C02F 3/08; C02F 103/00

(52) U.S. Cl. CPC C02F 3/20; C02F 3/08; C02F 2103/005; C02F 2203/006; C02F 2303/24

(57) ABSTRACT

A wastewater treatment system comprising an aeration system comprising a network of diffusers secured to a floor of a wastewater treatment tank, a sieve fluidically coupled to an inlet of the wastewater tank and configured to receive wastewater from a wastewater source, and a blower coupled to the aeration system and positioned outside of the wastewater treatment tank. The system may also include a biofilm carrier having increased surface area and configured as free floating in the wastewater. The diffusers comprise a plurality of apertures spaced apart along a length of each diffuser and wherein each diffuser is provided with an end cap having an opening therein for flushing solids, liquids or mixtures thereof from the diffuser, wherein the sieve comprises at least one mesh tube extending into the tank for filtering wastewater of solids as the wastewater enters the tank.

### CROSS-REFERENCE TO RELATED APPLICATION

This application claims priority to and the benefit of U.S. provisional patent application Ser. No. 63/589,373, filed on Oct. 11, 2023, the contents of which are incorporated herein in their entirety.

### BACKGROUND

The present invention relates to a wastewater treatment system and more specifically to a system configured to treat wastewater from a septic tank.

### SUMMARY

An aspect of the present disclosure relates to a wastewater treatment system comprising an aeration system comprising a network of diffusers secured to a floor of a wastewater treatment tank; a sieve fluidically coupled to an inlet of the wastewater tank and configured to receive wastewater from a wastewater source; and a blower coupled to the aeration system and positioned outside of the wastewater treatment tank, wherein the diffusers comprise a plurality of apertures spaced apart along a length of each diffuser and wherein each diffuser is provided with an end cap having an opening therein for flushing solids, liquids or mixtures thereof from the diffuser, and wherein the sieve comprises at least one mesh tube extending into the tank for filtering wastewater of solids as the wastewater enters the tank.

A free-floating biofilm carrier is provided to the tank, wherein the biofilm carrier comprises a hexagonal shape.

The aeration system comprises a plurality of diffuser mounts for securing the diffusers to the floor the wastewater treatment tank and spacing the diffusers from the floor of the tank.

Each of the plurality of diffuser mounts comprise a floor engaging base with one or more apertures for securing the mount to the floor and a recessed head portion having a diameter configured to frictionally engage an end of the diffuser therein to hold the diffuser in place.

The recessed head portion provides the end cap comprising the opening for flushing solids, liquids or mixtures thereof from the diffuser.

A manifold is secured to the floor of the tank and operably connected to the blower at a first end thereof and operably connected to each of the plurality of diffusers spaced apart along a length extending into and along the tank floor.

One or more manifold mounts for securing the manifold to the floor of the wastewater treatment tank and spacing the manifold from the surface of the floor of the tank.

The sieve comprises an inlet positioned above and fluidically coupled via a manifold to two rigid mesh tubes extending outwardly therefrom.

In one or more embodiments the wastewater source is a septic tank and the wastewater treatment tank is a moving bed bioreactor. The septic tank and moving bed bioreactor are fluidically connected with the sieve positioned in the water flow between the septic tank and moving bed bioreactor.

In one or more embodiments the wastewater source is a septic tank and the system further comprises a retrofit assembly comprising a housing which is fluidically connected to the septic tank and houses the aeration assembly and sieve and is configured to receive wastewater from the septic tank.

### BRIEF DESCRIPTION OF THE DRAWINGS

FIG. 1 is a perspective view of a septic tank assembly with a wastewater treatment system according to one or more embodiments described herein.

FIG. 2 is a top view of an aeration system inside the tank.

FIG. 3 is a perspective view of another embodiment of the wastewater treatment system installed in a septic tank.

FIG. 4 is a side view inside the tank showing an embodiment of the wastewater treatment system installed in the septic tank.

FIG. 5 is a perspective view of a diffuser of a diffuser assembly of the treatment system.

FIG. 6 is a bottom perspective view of a manifold mount assembly for the diffuser assembly.

FIGS. 7A-7B are front and back view of diffuser end cap mounts for the diffusers of the aeration system.

FIG. 8 is an exploded view of a manifold system of the aeration system of the treatment system.

FIG. 9 illustrates a retrofit assembly for a septic tank allowing the wastewater treatment system to be installed in new or existing septic tanks.

FIG. 10A is a perspective view of a diffuser end cap and FIG. 10B is another view showing the interior of the diffuser end cap.

FIGS. 11A-11E illustrates a sieve assembly for the wastewater treatment system.

FIGS. 12A-12B illustrate embodiments of a sieve baffle and sieve baffle weldment.

FIG. 13 illustrates a wastewater treatment tank with an air mixer assembly therein, with other operational components removed for ease of illustration.

FIGS. 14A and 14B are a side and top view of the wastewater treatment system tank with the air mixer assembly therein and FIG. 14C is an enlarged view of a portion of the air mixer assembly.

FIGS. 15A and 15B illustrate an air mixer tank of the air mixer assembly.

FIGS. 16A and 16B illustrate one embodiment of a biocarrier for biofilm growth for placement in the water treatment system tank.

### DETAILED DESCRIPTION

A wastewater treatment system is described herein. The treatment system is configured to treat wastewater with a combination of a diffuser system assembly, sieve assembly and optional bio carrier. The diffuser system assembly includes a network of diffusers with a manifold for delivery of air flow to the diffusers, the assembly comprising a plurality of diffuser mounts and manifold mounts which may be secured to the floor of a tank configured to receive a supply of wastewater for treatment. The mounts are configured with an opening to allow the diffuser assembly to be secured to the floor of the tank while also being spaced vertically from the floor of the tank. The diffuser mounts also allow the diffusers to be flushed for removal of solids or other deposits which may accumulate in the diffuser tubes.

The sieve assembly is positioned within the tank and can be fluidically connected to a wastewater source. The sieve assembly comprises one or more mesh tubes for removal of solids from the wastewater entering the tank for treatment.

The biofilm carrier is a device configured to be added to the wastewater in the tank and may be free floating within the tank. The device has a surface for growth of bacteria thereon for treatment of the wastewater. The shape of the bio carrier includes apertures therein for increased surface area and may have a geometric shape such as a hexagonal or open honeycomb shape. The biofilm carrier or media may be provided to the system, the media having the hexagonal design such that the media includes increased surface area with respect to biofilm carriers of the prior art. The media can be used in combination with the wastewater treatment system described herein or may be used in septic systems or tanks without said system. The media is designed for and capable of high density bacterial growth due to the large surface area of the media.

The wastewater treatment systems described herein may be incorporated into various sized septic systems, including water treatment systems having a moving bed bioreactor tank connected to the septic tank, and for example can be used with residential septic tanks. Retrofit enclosures can be used to house the wastewater treatment system described herein and the retrofit enclosure and wastewater system thus connected to a drain or drain field of a preexisting septic tank, thus receiving wastewater from the septic tank.

The wastewater treatment system according to one or more embodiments described herein can be used with small wastewater flows (e.g., hundreds of gallons per day) and is also scalable for large flows (e.g., millions of gallons per day). The system can be installed below ground in fiberglass or concrete tanks for example or above ground in steel, concrete and fiberglass tanks.

In one or more embodiments, the wastewater treatment system described herein provides an aeration system in the tank and in a septic system may be provided for use after and/or with a moving bed bioreactor (MBBR) process which pumps wastewater into the septic tank. In one or more embodiments, the wastewater treatment system may include the biofilm carrier(s) which provide a stable home for large populations of bacteria to grow and treat the wastewater. This can be coupled with the aeration system described herein to form an efficient wastewater treatment process. In one or more embodiments the system described herein is provided in a MBBR reactor or dose tank and can also be retrofit to upgrade existing septic systems.

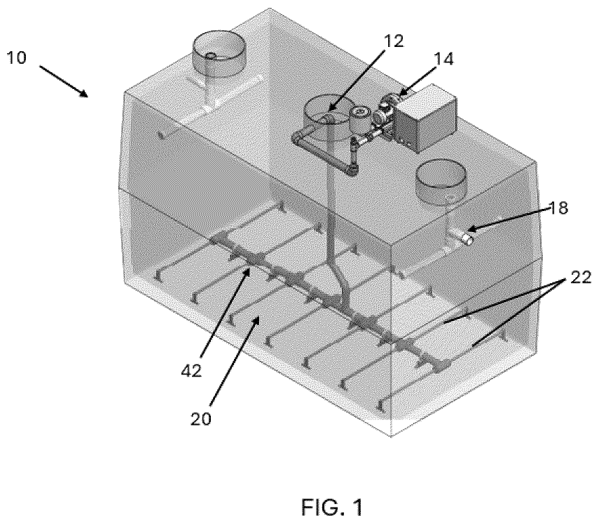

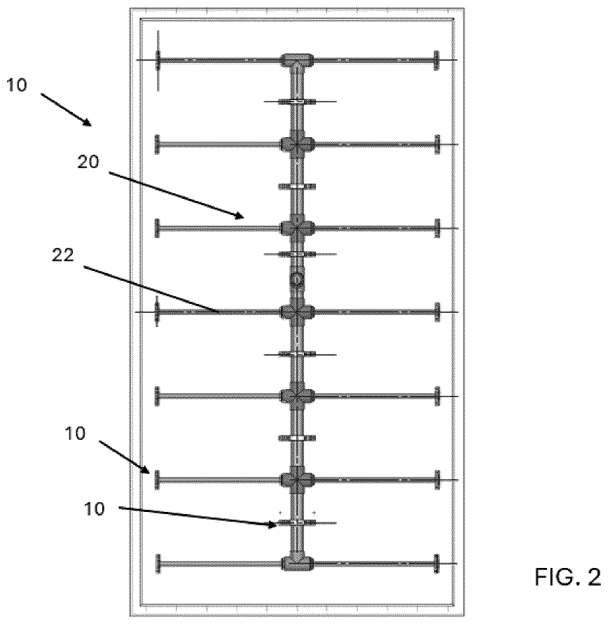

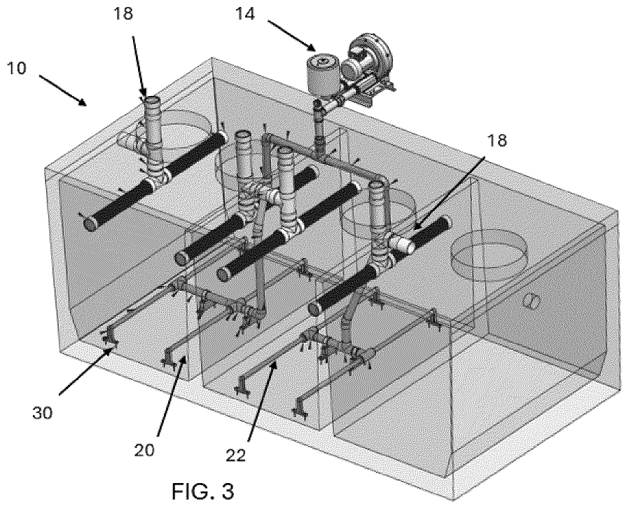

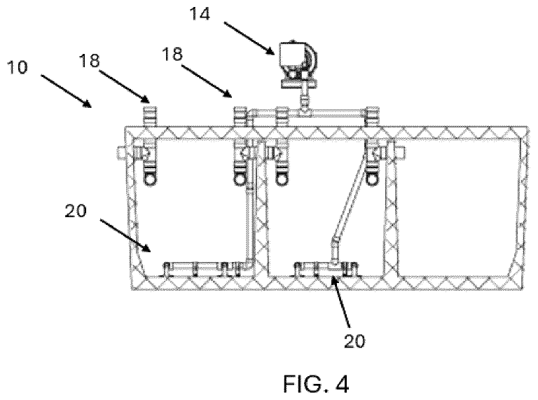

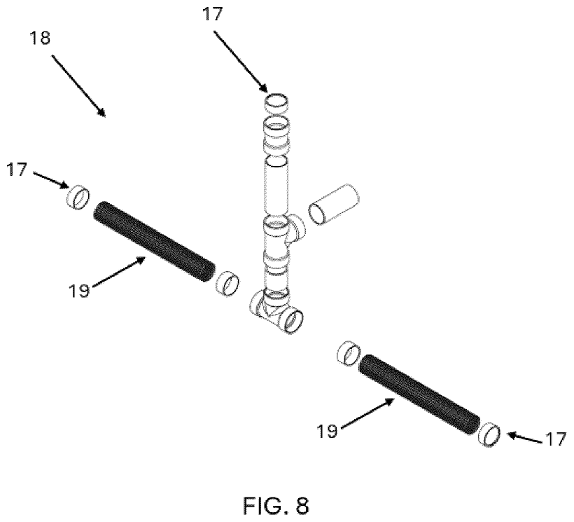

As shown in the figures, including FIGS. 1-8, a wastewater treatment system 10 comprises an aeration system 12, which may be anchored to a floor of the housing or tank 10 while also operably connected to a blower 14 that is positioned outside the tank 10 and/or above-ground for blower access and for on-demand and/or continuous air flow into the tank 10. Optionally, one or more biofilm collection media 16 (e.g., biofilm carrier) may be provided to the tank 10 where the collection media 16 is free floating within the interior of the tank 10. The aeration allows for mixing and/or movement of the contents within the tank 10 and the collection media 16 is buoyant within the contents of the tank 10 for growth of bacteria for treatment of the wastewater. The system further comprises a sieve assembly 18. The system is operator friendly and virtually maintenance free.

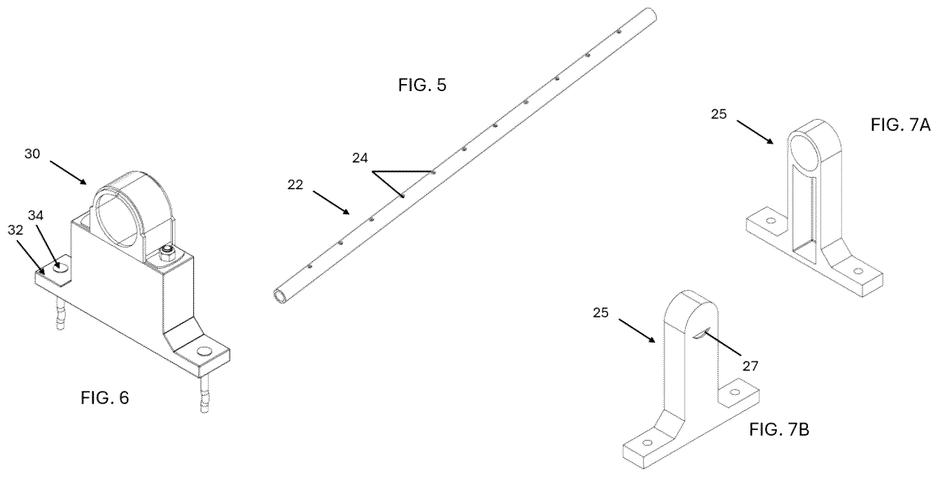

As shown in further detail in FIG. 5, the aeration system 12 comprises a diffuser system 20 which comprises one or more diffusers 22 which may be tubular in shape with at least a one inch diameter along the length of the diffuser 22. The diffusers 22 are provided in various lengths and diameters as required by the size of the tank 10. For example, the diffusers 22 may be one inch diameter diffusers with a plurality of spaced apart apertures 24 provided in the diffuser 22 along the length of the diffuser 22. The apertures 24 may be 4-6 mm holes with counter sinks. The apertures 24 may also have a bevel. The aperture 24 spacing may also vary from 2 inches between holes to 3, 4, 5, or 6 inches between apertures 24. Ends of the diffusers 22 may be capped with a closure mount 25 or a cap 26 having an aperture 27 or 28 therein wherein the end closure mount 25 or the cap 26 has an opening such as a half-moon opening 28 which allows for flushing of the diffuser 22. The end closure mount 25 is configured to mount the diffuser 22 to a surface inside the tank 10 and to space the diffuser 22 from the tank floor or wall. The openings 28 allow sludge or other build-up to be flushed out the end of the diffuser 22, keeping the apertures 28 clear for air flow. The diffusers 22 allow for air flow from an air flow source to pass along and through the diffuser 22 and into the tank 10, thus aerating and moving the wastewater treated therein For example, the one or more blowers 14 are provided operably connected to the diffuser system 20 and positioned outside the tank 10. The blower 14 may be a regenerative blower for providing air flow to the diffuser system.

As shown in FIGS. 6-7B, the diffuser system 20 further comprises a plurality of diffuser mounts 30. The diffuser mounts 30 secure the diffusers 22 to the floor or other surface of the tank or retrofit enclosure. The mounts 30 allow the diffusers 22 to be coupled to the floor with a space between the diffusers 22 and the floor for example. The mounts 30 are provided with a floor engaging base 32 having apertures 34 for use of fasteners to secure the mount 30 to the floor. The fasteners may be drive anchors for concrete or other bolts or the like configured to secure the mount to the material of the tank floor. The diffuser mount recess is configured to mate with the end of the diffuser and thus is provided in a diameter configured to couple via friction to the diffuser. In one or more embodiments, the diffuser 22 slides into the mount 30 and is anchored to the floor with stainless steel anchors.

The diffuser engaging or upper end of the mounts 30 may have a recessed portion to accept an end of the diffuser 22 therein to couple to and securely hold the diffuser 22. The upper end of one or more mounts 30 may have an aperture 36 therein such that the diffuser end is also capped by the mount and includes an opening for diffuser flushing. The mounts 30 may be provided at terminal ends of the diffusers to securely hold the diffusers in place. Additional mounts be used as necessary.

In one or more embodiments, the diffuser system comprises one or more manifolds 40 and manifold mounts 42 with anchors, with one embodiment as shown in the figures. The manifold mounts 42 may be provided for a manifold 40 which is operationally connected to the diffusers 22 at locations along the length of the manifold 40. The manifold 40 delivers air flow to the various diffusers 22. Along the length of the manifold 40 and spaced between diffuser connections with the manifold are manifold mounts 42. The manifold mounts are provided with a tank floor engaging base with apertures for receiving drive anchors or other fasteners. The manifold mount comprises a cushion and clamp, which may comprise a stainless steel pipe bracket for receiving the manifold there through and holding the manifold in place above the floor of the tank.

A manifold is provided and is sized depending on the size and/or flow of the tank. For example, the manifold may be a 1½, 3 or 4 inch diameter manifold. Similarly, the blower has an air volume that is selected based on the size of the tank. In one or more embodiments, the diffuser system is secured to the floor of the tank. The diffusers themselves are connected to and extend from connection with the manifold. For example, “T” bracket connections are provided such that the manifold is positioned between opposing diffuser branches such that the diffuser can cover the base of the tank.

The diffuser system is an assembly that may be comprised of various materials including piping such as PVC piping or other hard plastic piping. Additional components may be comprised of PVC or other hard plastic material and/or stainless steel components. The components must be able to withstand wastewater exposure and water pressure.

As shown in FIGS. 1, 3-4 and 8, the sieve assembly 18 allows for further removal of solids from the wastewater received from the septic tank to the MBBR tank or retrofit enclosure for example. In one embodiment, the sieve assembly 18 comprises an inlet with a vent 17 with a screen positioned above the inlet. Below the inlet, the tubing of the sieve extends outwardly from a “T” supporting two mesh tubes 19 each terminating in a vent screen 17. The mesh tubes may be open area rigid mesh tubes. The sieve 18 extends into the body of the tank 10, allowing the water to be added to the tank.

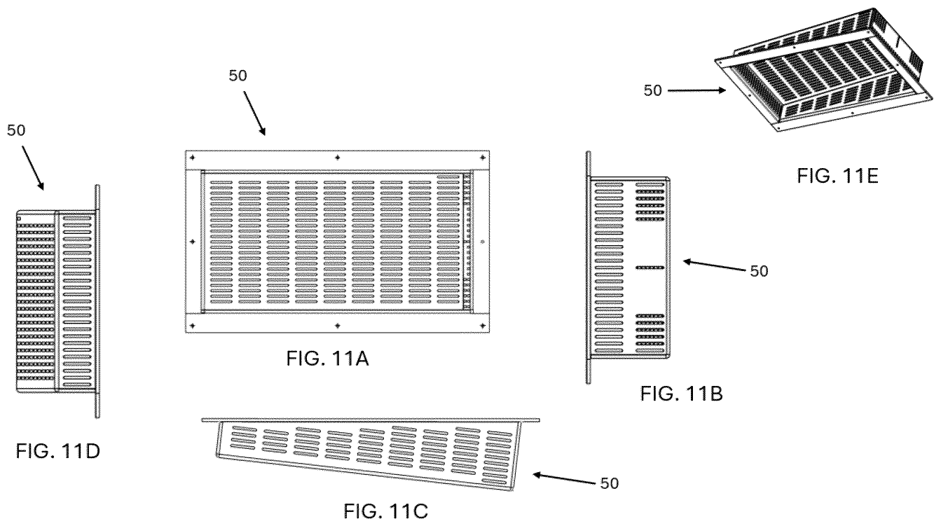

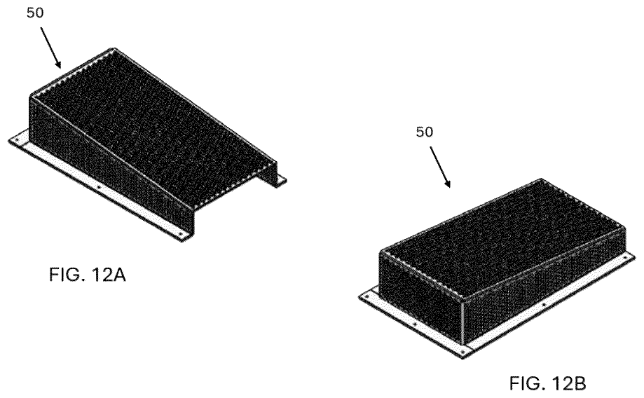

As shown in FIGS. 11A-12B, an additional or alternative sieve 50 for tanks including concrete tanks is illustrated. The sieve may be referred to as a sieve baffle 52 and as illustrated can be mounted to the wall of a concrete tank and around an inlet and prevents media from leaving or entering the tank. The sieve 52 comprises a mounting frame with an open bottom and an interior space therein. A top and sides of the sieve are perforated for preventing solids from entering or exiting the tank but allowing for the flow of fluid as needed.

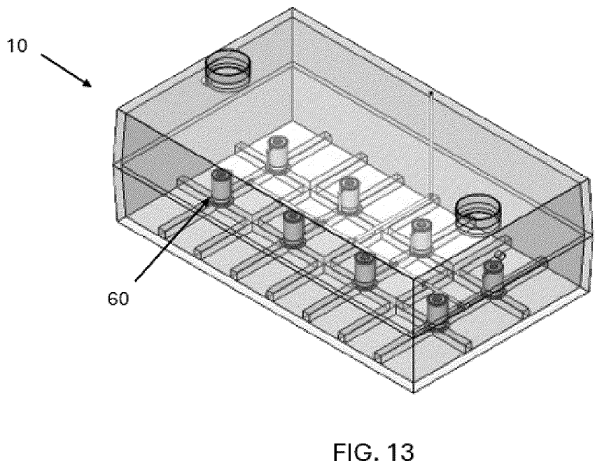

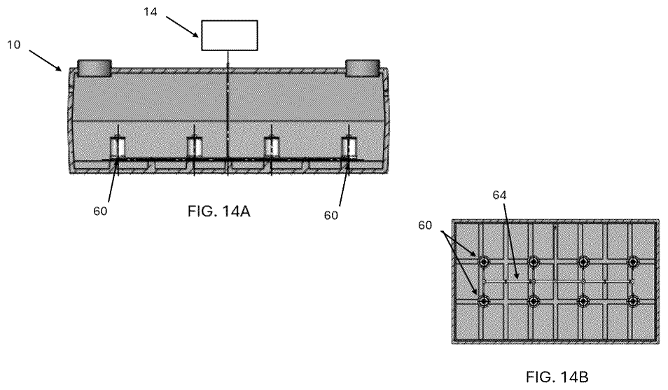

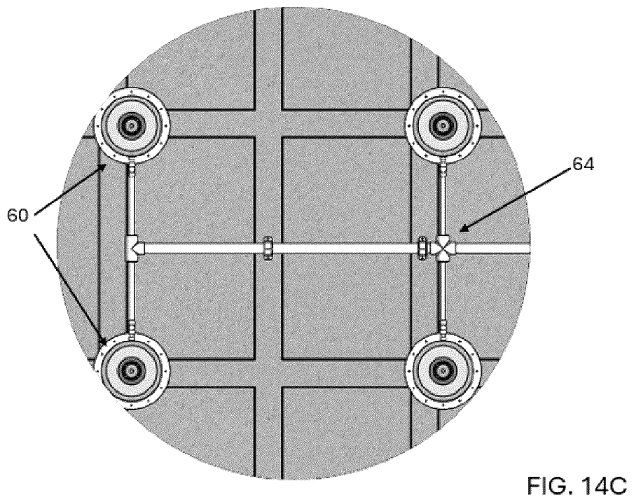

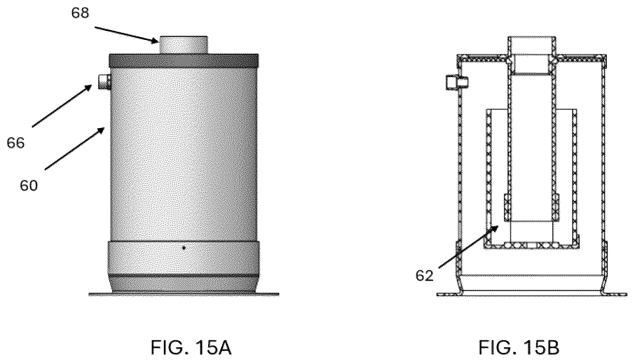

Additionally or alternatively, the aeration system 12 may comprise or further comprise one or more air mixers 60, which as illustrated in FIGS. 13-15B are air operated mixers 60 which may be installed in a bottom of the tank 10 and are designed to fill up an inner chamber 62 with air and then release the air in one large burst which mixes contents in the tank 10 and the media 16 in the tank 10. As shown in the figures, one or more mixer assemblies 60 can be mounted in a tank 10 and are operably connected to an air supply source, which may be the blower 14 (although this is not shown in the figures for clarity of illustration) positioned outside the tank by way of tubing 64 connecting one or more inlets of the mixer 60 to the air source. The inlet(s) 66 allow air to enter the inner chamber of the mixer and as the inlet connection to the air tubing is sealed, fluid if prevented from entering the chamber. Once the chamber is sufficiently filled with air, the air can be released in a single large burst through an outlet 68 of the mixer 60. The outlet comprises a one way valve only allowing air to leave the mixer. In embodiments where the mixer(s) 60 is/are provided with the diffuser system 20, the mixers 30 may be mounted on or near the diffuser mounts 30 or manifold mounts 40 or on a location of the diffusers 22 and may utilize the same air supply as provided to the diffuser system 20. The mixer(s) 60 may also be mounted to the floor or walls, or other mounting mechanisms, in the tank 10.

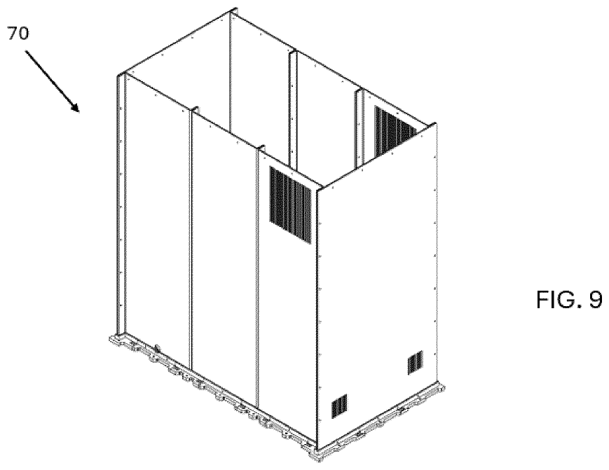

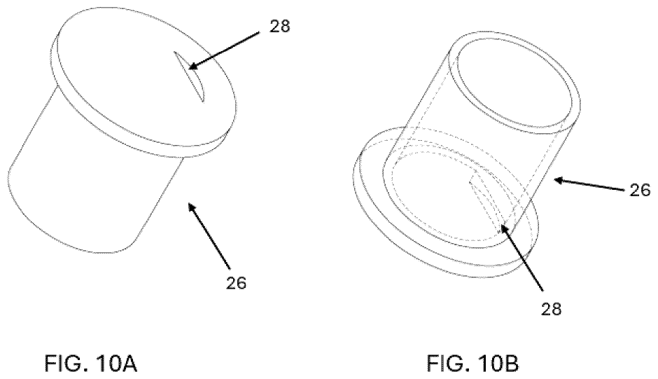

Retrofit assemblies are enclosures for the wastewater treatment system described herein. The retrofit assembly 70 provides the tank which houses the diffuser assembly, sieve assembly and biofilm carrier along with wastewater received from a wastewater source as shown in FIG. 9.

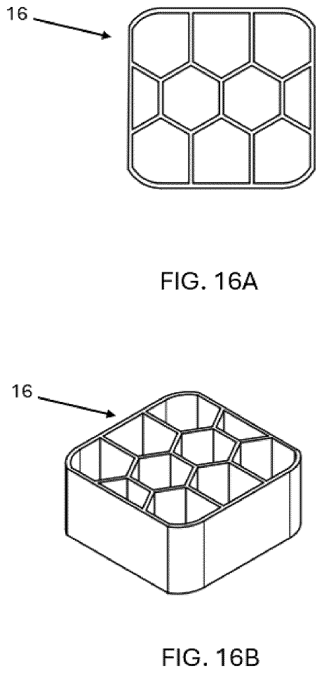

Embodiments of the biofilm carrier are shown in FIGS. 16A-16B. The biofilm carrier is configured for bacterial growth on surfaces thereof to treat the wastewater. The biofilm carrier may have a hexagonal shape with various openings having sidewalls such that the surface area of the carrier is increased.

Although the present disclosure has been described with reference to preferred embodiments, workers skilled in the art will recognize that changes may be made in form and detail without departing from the spirit and scope of the disclosure.

1. A wastewater treatment system comprising:
an aeration system comprising a network of diffusers secured to a floor of a wastewater treatment tank;
a sieve fluidically coupled to an inlet of the wastewater tank and configured to receive wastewater from a wastewater source; and
a blower coupled to the aeration system and positioned outside of the wastewater treatment tank,
wherein the diffusers comprise a plurality of apertures spaced apart along a length of each diffuser and wherein each diffuser is provided with an end cap having an opening therein for flushing solids, liquids or mixtures thereof from the diffuser, and
wherein the sieve comprises at least one mesh tube extending into the tank for filtering wastewater of solids as the wastewater enters the tank.

2. The wastewater treatment system of claim 1 and further comprising a free-floating biofilm carrier provided to the tank, wherein the biofilm carrier comprises a repeating pattern hexagonal shape.

3. The wastewater treatment system of claim 1 wherein the aeration system comprises a plurality of diffuser mounts for securing the diffusers to the floor the wastewater treatment tank and spacing the diffusers from the floor of the tank.

4. The wastewater treatment system of claim 3 wherein each of the plurality of diffuser mounts comprise a floor engaging base with one or more apertures for securing the mount to the floor and a recessed head portion having a diameter configured to frictionally engage an end of the diffuser therein to hold the diffuser in place.

5. The wastewater treatment system of claim 4 wherein the recessed head portion provides the end cap comprising the opening for flushing solids, liquids or mixtures thereof from the diffuser.

6. The wastewater treatment system of claim 1 and further comprising a manifold secured to the floor of the tank and operably connected to the blower at a first end thereof and operably connected to each of the plurality of diffusers spaced apart along a length extending into and along the tank floor.

7. The wastewater treatment system of claim 6 and further comprising one or more manifold mounts for securing the manifold to the floor of the wastewater treatment tank and spacing the manifold from the surface of the floor of the tank.

8. The wastewater treatment system of claim 1 wherein the sieve comprises an inlet positioned above and fluidically coupled via a manifold to two rigid mesh tubes extending outwardly therefrom.

9. The wastewater treatment system of claim 1 wherein the wastewater source is a septic tank and the wastewater treatment tank is a moving bed bioreactor.

10. The wastewater treatment system of claim 9 wherein the septic tank and moving bed bioreactor are fluidically connected with the sieve positioned in the water flow between the septic tank and moving bed bioreactor.

11. The wastewater treatment system of claim 1 wherein the wastewater source is a septic tank and the system further comprises a retrofit assembly comprising a housing which is fluidically connected to the septic tank and houses the aeration assembly and sieve and is configured to receive wastewater from the septic tank.

12. The wastewater treatment system of claim 1 and further comprising one or more air chambers positioned inside the tank for mixing contents and media in the tank.

13. The wastewater treatment system of claim 12 wherein the one or more air chambers are configured to fill with air and release substantially all of the air in the chamber in one burst of air into the tank for mixing contents of the tank.
